(19) United States
(12) Patent Application Publication
(10) Pub. No.: US 2005/0117031 A1
(43) Pub. Date: Jun. 2, 2005

(54) Virtual film roll for grouping and storing digital images

(76) Inventors: Virgil K. Russon, Greeley, CO (US); Michael L. Rudd, Fort Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/727,015

(22) Filed: Dec. 2, 2003

(51) Int. Cl. H04N 5/76

(52) U.S. Cl. 348/231.2

(57) ABSTRACT

A method, electronic device and archival storage system group digital images into a respective virtual fill roll (VFR) group. The method tags a digital image with a group tag. The group tag identifies the digital image as a member of a respective virtual film roll (VFR) group of digital images. The electronic device includes a computer program that includes instructions that implement applying the group tag to a digital image captured by the electronic device. The digital image archival storage system includes an image digitizer and an archival storage device. One or both of the digitizer and the storage device include at least a portion of a computer program. The computer program includes instructions that implement applying the group tag to the digital image captured by the image digitizer.

### BACKGROUND

1. Technical Field

The invention relates to electronic devices. In particular, the invention relates to organizing and storing digital images produced by and stored in electronic devices.

2. Description of Related Art

Popularity and use of digital cameras has increased in recent years as prices have fallen and image quality has improved. Among other things, digital cameras provide a camera user or photographer with an essentially instantly viewable photographic image. Furthermore, digital cameras generally capture and store images in a native digital format. The native digital format at least facilitates image distribution following an upload of the images from the digital camera to an archival storage and/or image processing system such as a personal computer (PC).

While having many advantages, digital cameras and digital photography in general also have several disadvantages. Among the disadvantages is a lack of a notion of a ‘roll of film’ in digital photography. Specifically, images in conventional film-based photography are ‘naturally’ or inherently grouped by virtue of being from or part of a particular roll of film. Photographers often employ the inherent ‘film roll’ relationship (i.e., images grouped by film roll) to understand aspects of the images in the group. Even after the film is developed, negatives and the photographic prints generated therefrom are typically packaged together in an envelope or similar package thereby essentially maintaining the useful ‘film roll’ grouping the images.

Accordingly, it would be advantageous to have a way of grouping and storing images produced by digital cameras, scanners, and other image-producing electronic devices that preserved a natural ‘film-roll’ relationship between images. Such a grouping and storing of images would solve a long-standing need in the area of digital photography and digital image archiving.

### BRIEF SUMMARY

In some embodiments of the present invention, a method of associating digital images is provided. The method comprises tagging a digital image with a group tag. The group tag identifies the digital image as a member of a respective virtual film roll (VFR) group of digital images.

In other embodiments of the present invention, an electronic device providing virtual film roll (VFR) image grouping is provided. The electronic device digitizes and stores images as digital images. The electronic device comprises a computer program, at least a portion of which is stored in the electronic device. The computer program comprises instructions that, when executed by means for controlling the electronic device, implement applying a group tag to a digital image captured by the electronic device. The applied group tag identifies the digital image with a respective virtual film roll (VFR) group of captured images.

In other embodiments of the present invention, a digital image storage system that employs virtual film roll (VFR) image grouping is provided. The digital image storage system comprises an image digitizer, and an archival storage device. One or both of the image digitizer and the archival storage device comprise at least a portion of a computer program. The computer program comprises instructions that implement applying a group tag to a digital image captured by the image digitizer. The group tag identifies the digital image with a respective virtual film roll (VFR) group of captured images.

Certain embodiments of the present invention have other features in addition to and in lieu of the features described hereinabove. These and other features of the embodiments are detailed below with reference to the following drawings.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1 illustrates a flow chart of an embodiment of a method of associating digital images using a virtual film roll (VFR) according to an embodiment of the present invention.

FIG. 2 illustrates a block diagram of an embodiment of a digital camera providing virtual film roll image grouping according to an embodiment of the present invention.

FIG. 3 illustrates a block diagram of an embodiment of a digital image storage system that employs virtual film roll image grouping according to an embodiment of the present invention.

### DETAILED DESCRIPTION

Embodiments of the present invention essentially create or establish a ‘virtual film roll’ for use in digital photography and related digital image creation modalities. In particular, the created virtual film roll (VFR) provides an association between images in a group of digital images in terms of a specific upload event, capture event, capture period, or similar logical relationship. The VFR association or grouping of the images thus formed is applied to and retained by individual digital images of the group. As such, the VFR grouping may be employed to search for and locate images within an archival storage system even though individual images of the group may have been moved from place to place within the archival storage system.

While described hereinbelow primarily in terms of images captured by a digital camera, embodiments of the present invention apply to any electronic device that captures and stores digital images including, but not limited to, a scanner, such as a flatbed or photographic scanner, a multifunctional machine that includes a scanning function and provides other functions, such as one or more of facsimile, printing and copying, for example, and any image digitizing and recording device. Therefore, it is not the intent herein to be limited to a particular electronic device.

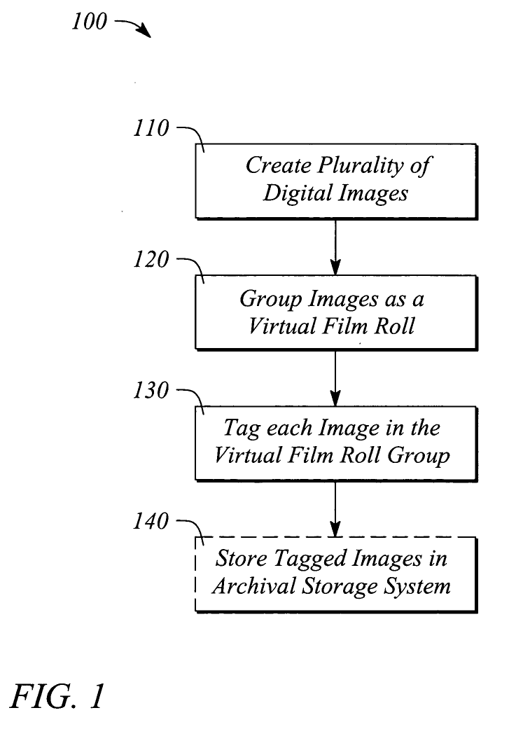

FIG. 1 illustrates a flow chart of an embodiment of a method 100 of associating digital images using a virtual film roll (VFR) according to an embodiment of the present invention. The method 100 of associating digital images comprises creating 110 a plurality of digital images. In some embodiments, creating 110 comprises ‘taking’ one or more photographs using a digital camera.

As used herein, ‘taking’ refers to a general process by which the digital camera captures and records an image as a digital image. In particular, optics of the digital camera focus an image onto an optoelectronic array (e.g., a CCD array). The optoelectronic array digitizes the image to produce a digital image thereby ‘capturing’ the image. As such, ‘digital image’ refers to a digitized image. Once captured, the digital image is recorded and stored in a memory. Thus, the digital camera creates 110 a plurality of digital images by taking several photographs.

In some embodiments, the digital image is recorded and stored in a memory of the digital camera as a digital image file (e.g., JPEG, GIF, TIF, BMP, etc.). In other embodiments, the digital image is recorded and stored in the camera memory as a data block or another arbitrary or proprietary data structure. For example, to save memory in the digital camera, the digital image may be stored in memory without an associated file name. In such embodiments, the digital image may be converted from the arbitrary data structure to a formal digital image file for transfer to and/or storage in one or more of a removable memory of the digital camera and an archival storage system. As such, the terms ‘digital image’ and ‘digital image file’ are used interchangeably and without distinction or intended limitation hereinbelow except where such interchangeability may cause confusion to one skilled in the art.

In another embodiment, creating 110 comprises employing a scanner or a scanning function of a multifunctional machine (hereinafter ‘scanner’ for simplicity only) to ‘scan’ one or more photographs or negatives of photographs. The scanner essentially digitizes the photographs to produce digital images. The digital images are converted into digital image files representing the scanned photographs. Thus, a plurality of digital image files are created 110 by scanning the photographs using the scanner. While described in terms of the exemplary digital camera and the exemplary scanner, any means of creating 110 digital images and/or files containing digital images is within the scope of embodiments of the present invention. The exemplary description herein is not intended to limit the scope of any embodiment of the invention.

The method 100 of associating digital images further comprises grouping 120 the images as a virtual film roll. As used herein, a ‘virtual film roll’ (VFR) is a grouping of images in which the images are related to one another by a particular event or events associated with one or both of image capture and image transfer to an archival storage system. Images of a VFR group are related to each other by one or more of an ordering of the images, a beginning to the group, and an end to the group. As the name implies, the VFR group is a digital image analog to a group of images from a single roll of photographic film in conventional film-based photography.

In some embodiments, a VFR group is defined as a group or set of images uploaded from the digital camera together during a single upload session or event. In other words, in such embodiments only the digital images that were actually transferred or moved from the digital camera to the archival storage system during a particular upload session are considered to be members of the particular VFR group of the session.

For example, during a first upload event that defines a first VFR group, if a set of digital images stored in the digital camera is transferred to the archival storage system, then all of the transferred digital images are members of the first VFR group. In another example, during a second upload session that defines a second VFR group, if only three digital images out of a total of five images stored in the digital camera memory are transferred, then only the three transferred digital images are part of the second VFR group.

For such upload event-based VFR groups, the ordering of images in a VFR group may be established by an order in which the images were created 110, for example. Alternatively, the ordering of images in a VFR group may be an order in which the images are uploaded during the upload event. Essentially any other meaningful ordering that may be applied to the images during the upload event may be used as the ordering for grouping 120 according to some embodiments.

Further for an upload event-based VFR group, the beginning of the VFR group may be established by a last or previous upload event, while an end to the VFR group is established by the present upload event, for example. In other words, the VFR group is essentially bounded by a last upload event and a present upload event in some embodiments. Thus, in such an exemplary VFR group, all images created 110 since the last upload event are uploaded in the present upload event and are included in the VFR group in some embodiments.

In another example, the beginning of the VFR group is simply a first image uploaded while the ending of the VFR group may be a last image uploaded during the present upload event in some embodiments. Such an exemplary beginning/ending of the VFR group may be usefully employed in those embodiments when the upload event does not involve uploading all digital image files created 110 since the last upload event.

In another example embodiment, a VFR group may be a group of digital images created 110 by scanning photographs or negatives of photographs, all of which are from a single roll of photographic film. Such a VFR group is called a ‘roll-based’ VFR group. The ordering of the images in the roll-based VFR group is the order in which the images are scanned according to this embodiment. The scan order corresponds to an order of the images on the original film roll in this embodiment. Similarly, a beginning and an ending of the exemplary VFR group correspond to a beginning and an end of the original film roll in this embodiment. Thus, the exemplary VFR grouping 120 mimics a natural grouping of the original roll of photographic film in this embodiment. Alternatively in other roll-based VFR groups, the beginning/ending and the ordering may be essentially arbitrarily determined during grouping 120. For example, the roll-based VFR group may include images created 110 from more than one roll of photographic film, where the rolls are related by one or more of subject, date, photographer, and the like. Many additional VFR groupings may be devised by one skilled in the art and still be within the scope of the present invention.

The method 100 of associating digital images further comprises tagging 130 each image in the VFR group with a VFR group tag. The VFR group tag is an identifier that is associated with each image in the VFR group. The VFR group tag provides one or both a specific or unique VFR group identification and an ordering of the images within the group, depending on the embodiment. For example in some embodiments, the VFR group tag for a second image in a VFR group uploaded on Sep. 3, 2003 at 5:03 pm might be ‘0903031703-2’ or an equivalent. The VFR group tag may also provide an indication, either implicitly or explicitly, of the group beginning and group ending. A variety of VFR group tags may be employed in tagging 130, only an exemplary few of which are described herein. However, any VFR group tag devisable by one skilled in the art is within the scope of the embodiments of the present invention.

For example, a filename or portion thereof associated with a digital image file containing the digital image may be employed as the VFR group tag during tagging 130, depending on the embodiment. In some embodiments, the VFR group tag may comprise a group-specific file name, wherein a first portion of the filename identifies the group and a second portion provides an ordering of the image within the group. Thus, a VFR group tagged filename, such as ‘R0903031703-2.JPG’, may be employed to tag 130 an image file, wherein the image is the second image in the VFR group uploaded on Sep. 3, 2003, for example.

Alternatively or in addition to filename-based tagging 130, the VFR group tag may comprise metadata added to the digital image file containing the digital image, depending on the embodiment. In general, ‘metadata’ is ‘data about or regarding data’. As used herein, ‘metadata’ is data added to or included in a digital image file that is part of an object, where the object is the digital image contained by the digital image file. Thus in some embodiments, the VFR group tag used for tagging 130 may be added to the digital image file as metadata in the form of a comment block in a JPEG file header, for example. In another example, a metadata VFR group tag in the form of a ‘digital watermark’ may be added to digital image data within the file in some embodiments. A ‘digital watermark’ is data embedded within the image data that, while generally not interfering with the image, provides information that may be extracted or separated from the image data. As such, a digital watermark containing the VFR group tag may be employed in tagging 130 according to some embodiments. Metadata including, but not limited to, file headers and digital watermarks, embed the VFR group tag in the file containing the digital image, thus possibly reducing a chance that the VFR group tag is removed accidentally or on purpose in subsequent processing and/or storage to the digital image file.

In yet another example, tagging 130 comprises creating a catalog database of the digital images within the VFR group in some embodiments. In such embodiments, the group tags are stored separately from the digital image files. The database containing the VFR group tags may comprise simply an ordered list of the filenames within the VFR group, for example. As such, the presence of the filenames in the database acts as the group tags. Further in such an exemplary ordered listing, an order of the filenames is employed to record the order of the images within the VFR group. Thus, the catalog database may be a text file containing an ordered list of filenames of digital images that are members of the VFR group, according to some embodiments. The catalog database may contain additional details about the listed image files including, but not limited to, image creation date, image file size, location where the image was created, and subject of the image depending on the embodiment. Alternatively, the catalog database may be a relational database and/or may employ other than a text format for listing the filenames.

Tagging 130 may take place or occur at any of several times after an image is created 110 according to some embodiments. Tagging 130 may occur concomitant with the image creation 110, during or part of image grouping 120, during an upload event, following an upload event, or at other times, depending on the embodiment. For example, as images are created 110 by taking pictures with a digital camera, the digital images or image files may be tagged 130 with a metadata VFR tag based on a grouping defined by a last upload event. In another example, images may be tagged 130 during an upload from the digital camera to an archival storage system. In yet another example, images may be tagged 130 during a post upload processing of the uploaded image files following an upload event. In some embodiments, the digital images are tagged 130 during an upload event, or as soon as possible thereafter, to reduce a probability that the VFR group information is lost or otherwise obscured by other post-processing within the archival storage system. These and other tagging 130 examples not described but readily devisable by one skilled in the art are within the scope of various embodiments herein. Moreover, a similar set of tagging 130 examples and other tagging 130 examples apply to images created 110 with a scanner.

The method 100 of associating digital images optionally further comprises storing 140 the VFR group of digital image files in an archive storage system. For example, the digital image files may be stored 140 one or more of on a disk drive of a personal computer, on a removable media storage device (e.g., floppy disk or flash card), on a network accessible disk drive of a file server, and on an Internet file server, depending on the embodiment.

Accordingly, the VFR tags provide an association between individual digital image files that are members of a specific VFR group. The VFR group tags may be employed to search for and/or organize image files of the VFR group images within the archival storage system. Even if the images in the specific VFR group have been moved or otherwise dispersed with the archival storage system, the VFR tag may be employed to one or more of locate images, recognize a VFR group and reassemble a VFR group. The VFR group tag essentially preserves the VFR grouping 120 of the images when employing the method 100 of associating digital images according to some embodiments.

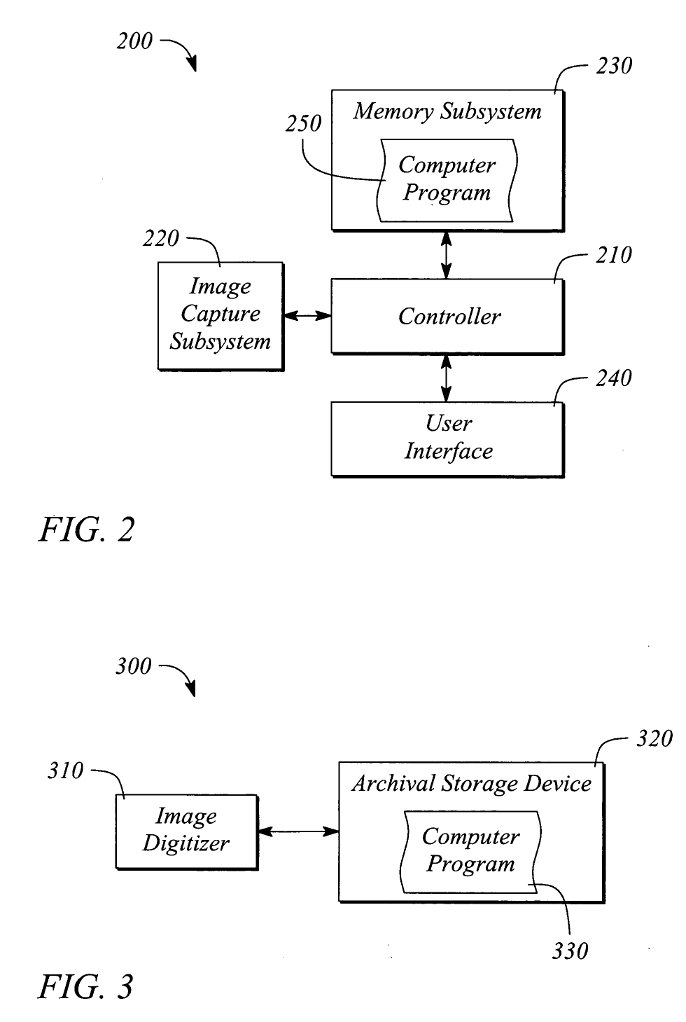

FIG. 2 illustrates a block diagram of an embodiment of a digital camera providing virtual film roll image grouping according to an embodiment of the present invention. As illustrated in FIG. 2, the digital camera 200 comprises a controller 210, an image capture subsystem 220, a memory subsystem 230, a user interface 240, and a computer program 250. In some embodiments, the computer program 250 is stored in the memory subsystem 230 and executed by the controller 210.

The controller 210 interfaces with and controls the operation of each of the image capture subsystem 220, the memory subsystem 230, and the user interface 240. Images captured by the image capture subsystem 220 are transferred to the memory subsystem 230 by the controller 210 and may be displayed for viewing by a user of the digital camera 200 on a display unit of the user interface 240.

The controller 210 may be any sort of component or group of components capable of providing control and coordination of one or more of the image capture subsystem 220, memory subsystem 230, and the user interface 240. For example, in some embodiments, the controller 210 is a microprocessor or microcontroller. Alternatively in other embodiments, the controller 210 is implemented as an application specific integrated circuit (ASIC) or even an assemblage of discrete components. One or more of a digital data bus, a digital line, and an analog line may provide interfacing between the controller and the image capture subsystem 220, memory subsystem 230, and the user interface 240, depending on the embodiment. In some embodiments of the digital camera 200, a portion of the memory subsystem 230 may be combined with or part of the controller 210.

In an embodiment, the controller 210 comprises a microprocessor and a microcontroller. Typically, the microcontroller provides much lower power consumption than the microprocessor and is used to implement low power-level tasks, such as monitoring button presses of the user interface 240 and implementing a real-time clock function of the digital camera 200. The microcontroller is primarily responsible for controller 210 functionality that occurs while the digital camera 200 is in a ‘stand-by’ or a ‘shut-down’ mode. The microcontroller executes a simple computer program. In some embodiments, the simple computer program is stored as firmware in read-only memory (ROM). The ROM is built into the microcontroller, depending on the embodiment.

On the other hand, the microprocessor implements the balance of the controller-related functionality. The microprocessor is responsible for all of the computationally intensive tasks of the controller 210, including but not limited to, image formatting, file management of the file system in the memory subsystem 230, and digital input/output (I/O) formatting for an I/O port or ports of the user interface 240.

In some embodiments, the microprocessor executes a computer program generally known as an ‘operating system’ that is stored in the memory subsystem 230. Instructions of the operating system implement the control functionality of the controller 230 with respect to the digital camera 200. In such embodiments, the computer program 250 may be a portion of the operating system. Alternatively, the computer program 250 may be separate from the operating system, depending on the embodiment.

The image capture subsystem 220 comprises optics and an image sensing and recording circuit. In some embodiments, the sensing and recording circuit comprises a charge coupled device (CCD) array. During operation of the digital camera 200, the optics project an optical image onto an image plane of the image sensing and recording circuit of the image capture subsystem 220. The optics may provide either variable or fixed focusing, as well as optical zoom (i.e., variable optical magnification) functionality, depending on the embodiment. The optical image, once focused, is captured and digitized by the image sensing and recording circuit of the image capture subsystem 220.

The controller 210 controls the image capturing, the focusing, and the zooming functions of the image capture subsystem 220. When the controller 210 initiates the action of capturing an image, the image capture subsystem 220 digitizes and records the image. The recorded image is transferred to and stored in the memory subsystem 230 as an image file. The recorded image may also be displayed on a display of the user interface 240 for viewing by a user of the digital camera 200, as mentioned above.

The memory subsystem 230 comprises memory for storing digital images, as well as for storing the computer program 250 and operating system of the digital camera 200. In some embodiments, the memory subsystem 230 comprises a combination of non-volatile memory (such as flash memory) and volatile memory (e.g., random access memory or RAM). The non-volatile memory may be a combination of removable and non-removable memory and depending on the embodiment, the non-volatile memory is used to store the computer program and image files, while the RAM is used to store digital images from the image capture subsystem 220 during image processing. The memory subsystem 230 may also store a directory of the images and/or a directory of stored computer programs therein, including the computer program 250, depending on the embodiment.

The user interface 240 comprises means for interfacing the controller 210 with a user of the digital camera 200, including but not limited to, one or more buttons, switches and displays. In some embodiments, the display is a liquid crystal display (LCD). Depending on the embodiment, one LCD display provides the user with an indication of a status of the digital camera 200 while another display is employed by the user to view images captured and recorded by the image capture subsystem 220. The various means for interfacing of the user interface 240 provide control input for controlling the operation of the digital camera 200. For example, a button may serve as an ‘ON/OFF’ switch for the camera 200, depending on the embodiment. In some embodiments, the user interface 240 is employed by the camera user to select from and interact with various modes of the digital camera 200 including, but not limited to a mode or modes associated with an execution and operation of the computer program 250.

The computer program 250 comprises instructions that, when executed by the controller 210, tag a group of images captured by the digital camera 200 with a virtual film roll (VFR) tag or identifier. In some embodiments, the instructions of the computer program 250 implement grouping of a plurality of captured images as a VFR group and tagging individual images within the group with a VFR tag once the image capture subsystem 220 has captured the images. The computer program 250 optionally may have instructions that implement capturing a plurality of digital images. Thus in some embodiments, the instructions of the computer program 250 may essentially implement any of the above-described embodiments of the method 100 of associating digital images.

In other embodiments, the instructions of the computer program 250 implement VFR grouping and tagging during an upload of the images from the digital camera 200. In such embodiments, VFR grouping and tagging may be essentially VFR grouping 120 and VFR tagging 130 described hereinabove with respect to various embodiments of the method 100. As mentioned hereinabove, image capturing need not be explicitly part of the computer program 250 in such embodiments.

FIG. 3 illustrates a block diagram of an embodiment of a digital image storage system 300 that employs virtual film roll image grouping according to an embodiment of the present invention. The digital image storage system 300 comprises means for capturing 310 digital images and means for storing 320 the captured digital images. The digital image storage system 300 further comprises a computer program 330. While illustrated as resident in the means for storing 320, the computer program 330, or portions thereof, may reside in and be executed by one or both of the means for capturing 310 and the means for storing 320, depending on the embodiment. Instructions of the computer program 330 implement grouping the digital images as a virtual film roll (VFR) and applying a VFR tag to each image in the VFR group when so executed. Thus, in some embodiments, the computer program 330 essentially may implement at least grouping 120 and tagging 130 with respect to any of the various embodiments of the method 100 of image grouping described hereinabove.

In some embodiments, the means for capturing 310 is one or more of an exemplary digital camera, a scanner, a multifunctional machine that includes a scanning function, and any other means for capturing 310 that digitize and record images, such as an image digitizer and recorder. Hereinafter, the means for capturing 310 is collectively referred to as ‘digital camera 310’ for simplicity of discussion only and not by way of limitation. In some embodiments, the means for storing 320 is one or more of an exemplary personal computer (PC), a microprocessor, a file server, network disk drive, an internet file storage site and any other means for storing that stores 320 archival images, such as an image storage device. Likewise hereinafter, the means for storing 320 is collectively referred to as ‘personal computer (PC) 320’ for simplicity of discussion only and not by way of limitation.

When the computer program 330 is resident in and executed by the PC 320, the computer program 330 may be a portion of an upload driver of the PC 320, depending on the embodiment. The upload driver moves files from the digital camera 310 to an archival memory of the PC 320. Thus, the instructions of the computer program 330 that implement the VFR grouping and VFR tag application are implemented in response to uploading of images from the digital camera 310 to the PC 320. In some embodiments, the instructions of the computer program 330, when executed by the PC 320, group the images as a VFR group and apply the VFR tag to each of the images. Depending on the embodiment, the instructions may insert metadata into each of the images wherein the metadata includes a group identifier and an image order of each image. Alternatively, the instructions may assign filenames to each image wherein a portion of the filename identifies the VFR group and image order, depending on the embodiment.

In other embodiments (not illustrated), the computer program 330 may be a portion of an upload driver resident in and executed by the digital camera 310. While resident in the digital camera 310, the computer program 330 may be essentially similar to the above-described computer program 330 resident in the PC 320, or may be a different computer program 330 that provides one or more of VFR grouping and VFR tagging of images, depending on the embodiment. In either case, the computer program 330 is used in conjunction with the digital camera 310 in response to an upload event that transfers the images as a VFR-tagged group from the camera 310 to the PC 320 for storage.

When the means for capturing 310 is a scanner 310, the VFR grouping and the VFR tag application occur in response to scanning a group of images such as, but not limited to, photographic images from a roll of photographic film. The computer program 330 may be a portion of a scanner control program (collectively referred to herein as ‘program 330’) in such embodiments. During scanning, the program 330 groups the scanned images as a VFR group and applies the VFR tags to the images within the group in a similar way that the above-described computer program 330 does. Such a program 330 may be executed by the means for storing 320 or an equivalent functionality in the scanner, depending on the embodiment.

Thus, there has been described a method of associating digital images using a virtual film roll (VFR). In addition, a digital camera and a digital image storage system that employ virtual film roll image grouping have been described. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

1. A method of associating digital images, the method comprising:
tagging a digital image with a group tag that identifies the digital image as a member of a respective virtual film roll (VFR) group of digital images.

2. The method of associating of claim 1, wherein the respective VFR group is an upload event-based VFR group.

3. The method of associating of claim 1, wherein the respective VFR group is a roll-based VFR group.

4. The method of associating of claim 1, wherein the group tag further orders the digital image within the respective VFR group relative to other digital images of the respective VFR group.

5. The method of associating of claim 1, further comprising storing the tagged digital image of the respective VFR group in an archive memory.

6. The method of associating of claim 5, wherein the tagged digital image is retrievable from the archival memory using the group tag, the group tag comprises data that distinguishes the digital image from other tagged digital images of the respective VFR group and further distinguishes the digital image from digital images in other VFR groups.

7. The method of associating of claim 1, further comprising:
capturing a plurality of digital images before tagging; and
grouping a set of the digital images of the plurality as the respective VFR group before tagging.

8. The method of associating of claim 7, wherein capturing the plurality of digital images comprises digitizing an image and recording the digitized image using a digital camera.

9. The method of associating of claim 7, wherein capturing the plurality of digital images comprises scanning one or both of a negative and a photograph from a roll of photographic film.

10. The method of associating of claim 7, wherein each digital image of the respective VFR group is tagged with the group tag, the group tag further ordering each digital image within the plurality relative to other digital images of the respective VFR group, such that each digital image of the respective VFR group comprises a unique group tag including data that distinguishes each digital image from others within the respective VFR group and that distinguishes from digital images of a different VFR group.

11. The method of associating of claim 10, further comprising storing the respective VFR group in an archival memory after tagging, each digital image of the respective group being separately retrievable from the archival memory using the unique group tag for each digital image.

12. A method of associating digital images, the method comprising:
applying a group tag to a digital image, the group tag identifying the digital image with a respective virtual film roll (VFR) group, the digital image being a member of a set digital images related to one another either by being uploaded as a set during an upload event or by being created from a roll of photographic film.

13. The method of associating of claim 1 1, wherein the group tag comprises data that distinguishes the digital image from other digital images of the respective VFR group and further distinguishes the digital image from digital images of other VFR groups.

14. The method of associating of claim 12, further comprising before applying:
capturing the digital image; and
grouping the captured digital image in the respective VFR group,
wherein capturing comprises digitizing and recording one of the digital image or one or both of a negative and a photograph from the roll of photographic film.

15. The method of associating of claim 11, further comprising storing the respective VFR group in an archival memory after applying, wherein the digital image of the respective VFR group is separately retrievable from the archival memory using the group tag.

16. An electronic device that digitizes and stores images as digital images, the device comprising:
a computer program, at least a portion of which is stored in the electronic device, the computer program comprising instructions that, when executed by means for controlling the electronic device, implement applying a group tag to a digital image captured by the electronic device, the group tag identifying the digital image with a respective virtual film roll (VFR) group of captured images.

17. The electronic device of claim 16, wherein the group tag comprises data that distinguishes the respective VFR group of captured images from other groups of captured images, the group tag further distinguishing the digital image of the respective VFR group from other captured images of the respective VFR group.

18. The electronic device of claim 16, wherein the computer program further comprises instructions that implement capturing a plurality of digital images with the electronic device, the digital image having the applied group tag being a digital image of the plurality.

19. The electronic device of claim 18, wherein the instructions that apply the group tag further apply the group tag to each digital image of the plurality of digital images, the group tag for each digital image within the respective VFR group being unique, such that each digital image is distinguishable from one another in the respective VFR group as well as being distinguishable from other groups of captured images.

20. The electronic device of claim 16, wherein the respective VFR group comprises a set of digital images uploaded together during a single upload event.

21. The electronic device of claim 16, wherein the respective VFR group comprises digital images created by scanning one or both of negatives and photographs, the negative and photographs having been produced from a roll of photographic film.

22. The electronic device of claim 16, further comprising:
means for capturing an image;
means for storing at least the portion of the computer program; and
means for controlling the means for capturing and the means for storing.

23. The electronic device of claim 16 implemented as one or more of a digital camera, a digital video camera, a scanner, a multifunctional machine that includes a scanning function, and an image digitizer and recorder.

24. A digital image storage system comprising:
an image digitizer; and
an archival storage device,
wherein one or both of the image digitizer and the archival storage device comprise at least a portion of a computer program, the computer program comprising instruction that implement applying a group tag to a digital image captured by the image digitizer, the group tag identifying the digital image with a respective virtual film roll (VFR) group of captured images.

25. The storage system of claim 24, wherein the image digitizer is a digital camera and the respective VFR group of captured images comprises a set of images uploaded from the digital camera to the archival storage device during a single upload session.

26. The storage system of claim 24, wherein the image digitizer is a scanning device, the respective VFR group comprising digital images produced by scanning one or both of negatives and photographs from a roll of photographic film.

27. The storage system of claim 24, wherein the computer program further comprises instructions that implement one or more of capturing a plurality of digital images with the image digitizer, grouping captured digital images with the respective VFR group of captured images, and storing the respective VFR group in the archival storage device, the group tag facilitating retrieval of any digital image of the respective VFR group from the archival storage device.

28. A digital image storage system comprising:
means for capturing digital images; and
means for storing digital images,
wherein one or both of the means for capturing and the means for storing comprise at least a portion of a computer program, the computer program comprising instructions that implement grouping the digital images as a respective virtual film roll (VFR) group and applying a group tag to the digital images of the respective VFR group in response to one or both of uploading the digital images to the means for storing and scanning a group of images, the group tag identifying the digital images with the respective VFR group.

29. The storage system of claim 28, wherein the means for capturing comprises one or more of a digital camera, a digital video camera, a scanner, a multifunctional machine including a scanning function, and an image digitizer and recorder.

30. The storage system of claim 28, wherein the means for storing digital images comprises one or more of a personal computer, a disk drive, a file server, a network disk drive, an internet file storage site and an archival storage device.
